(19) United States
(12) Patent Application Publication
(10) Pub. No.: US 2018/0077389 A1
(43) Pub. Date: Mar. 15, 2018

(54) ACTIVE WATERCRAFT MONITORING

(71) Applicant: The Talaria Company, LLC (d/b/a Hinckley Yachts), Portsmouth, RI (US)

(72) Inventors: Scott Bryant, Barrington, RI (US); Kevin Tucker, Newport, RI (US)

(21) Appl. No.: 15/361,553

(22) Filed: Nov. 28, 2016

Related U.S. Application Data
(60) Provisional application No. 62/393,196, filed on Sep. 12, 2016.

(51) Int. Cl. H04N 7/18; G06T 11/60; H04N 5/232; B63B 49/00

(52) U.S. Cl. CPC H04N 7/181; G06T 11/60; H04N 5/23293; G06T 2207/10004; G06T 2207/20221; G06T 2207/10016; B63B 49/00

(57) ABSTRACT

Methods and apparatus for active watercraft monitoring. A system includes cameras positioned on a watercraft to capture real time images of regions directly forward, rearward and laterally of the watercraft, and an active watercraft monitoring process residing in a computing device positioned in the watercraft, the active watercraft monitoring process receiving real time video images from the cameras, processing the real time video images and generating a simulated image of the vessel in relationship to its surroundings in conjunction with the processed real time video images

### CROSS REFERENCE TO RELATED APPLICATIONS

This application claims priority under 35 USC § 119(e) to U.S. Provisional Application Ser. No. 62/393,196, filed on Sep. 12, 2016, and entitled “Active Watercraft Monitoring,” the entire contents of which are hereby incorporated by reference.

### BACKGROUND OF THE INVENTION

The present invention generally relates to monitoring, and more specifically to active watercraft monitoring.

In recent years, many watercraft, such as boats, are provided with a camera system having an onboard camera that is used to capture an image of a region adjacent to a boat. The image is then displayed on an image displaying device, which is installed inside the boat so that an operator can accurately ascertain a situation in the region adjacent to the boat. The image displaying device is typically located on the instrument panel, or at any other suitable location within the passenger compartment of the boat. One of the most common boat camera systems includes a rearview camera that is automatically activated so as to display an image captured by the rearview camera upon determining that the transmission has been shifted into reverse.

What is needed is an around-view monitoring system to capture images of the surrounding peripheral area of the boat.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The present invention generally relates to monitoring, and more specifically to active watercraft monitoring.

In one aspect, the invention features a system including cameras positioned on a watercraft to capture real time images of regions directly forward, rearward and laterally of the watercraft, and an active watercraft monitoring process residing in a computing device positioned in the watercraft, the active watercraft monitoring process receiving real time video images from the cameras, processing the real time video images and generating a simulated image of the vessel in relationship to its surroundings in conjunction with the processed real time video images.

In another aspect, the invention features a method including receiving real time video images from cameras positioned on and about a vessel, and generating a composite image from the received real time video images, the composite image including a simulated image of the vessel depicted in its surrounding environment.

In still another aspect, the invention features a non-transitory computer readable medium including instructions to be executed by a processor-based device, wherein the instructions, when executed by the processor-based device, perform operations, the operations including receiving real time video images from cameras positioned on and about a vessel, and generating a composite image from the received real time video images for display, the composite image including a simulated image of the vessel depicted in its surrounding environment.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

The invention will be more fully understood by reference to the detailed description, in conjunction with the following figures, wherein:

FIG. 1 is an illustration of an exemplary active watercraft monitoring system adapted to a host vessel in accordance with one disclosed embodiment.

FIG. 1A is a block diagram of the active watercraft monitoring system of FIG. 1.

FIG. 2 is an exemplary displayed image that includes a simulated graphical representation of a vessel in the middle of its surroundings captured by the video cameras and consolidated by an active watercraft monitoring process.

FIG. 3 is a flow diagram of an active boat monitoring process.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

In the description below, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

The present invention enables watercraft owners to visualize the close proximity surroundings of their vessel using multiple live video camera feeds. The live video feed is processed and then projected to a visible screen on the vessel as a simulated image. The video stream generating the simulated image is live such that a distance of nearby obstacles can be accounted for visually when operating a vessel in close proximity to any obstacles, vessels, moorings, docks and so forth.

A simulated top-view image is achieved by utilizing various video feeds from cameras placed on the vessel. These video feeds are then stitched together in a computing device using live video to produce a consolidated, uniform, simulated top view image. The simulated image that the user sees includes a graphical representation of their vessel in the middle of the surroundings captured by the video cameras and consolidated by software executing in the computing device.

The system of the present invention can turn on automatically when a vessel is placed into an operational mode that optimizes maneuverability. In embodiments, the system of the present invention may be used while the vessel is under normal running modes.

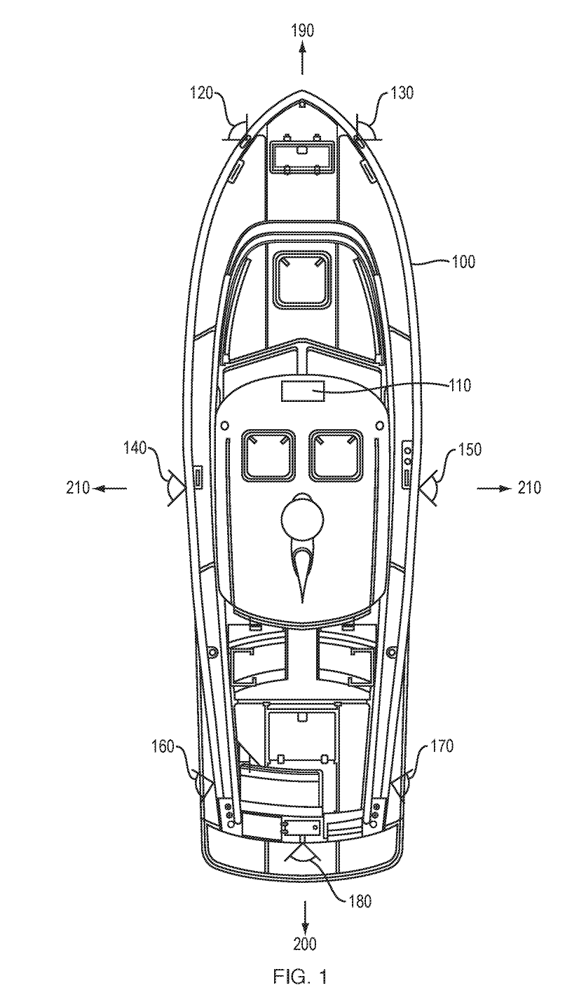

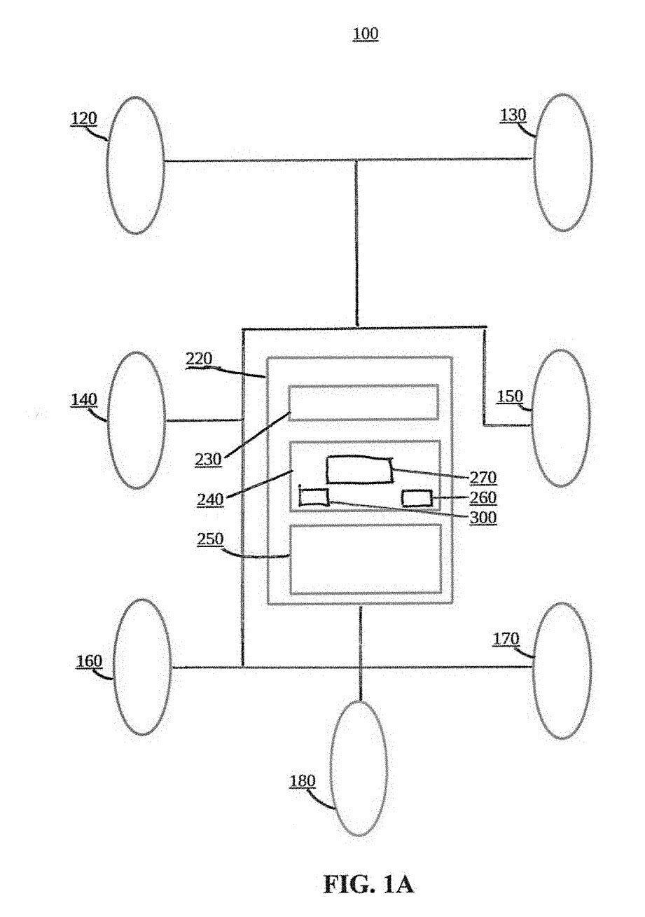

As shown in FIG. 1, a watercraft 100, such as a boat or other vessel that travels on water, is illustrated that includes an active watercraft monitoring system 110 in accordance with principles of the present invention. The active watercraft monitoring system 110 is equipped with a number of onboard video cameras that includes a forward port side camera 120, a forward starboard side camera 130, an amidships port side camera 140, an amidships starboard side camera 150, an astern port side camera 160, an astern starboard side camera 170 and a stern camera 180. The cameras 120, 130, 140, 150, 160, 170, 180 collectively constitute an image capturing device of the illustrated embodiment, which is configured and arranged to sequentially capture images (video) of the regions directly forward 190, rearward 200 and laterally 210 of the watercraft 100. Moreover, as explained below, the cameras 120, 130, 140, 150, 160, 170, 180 collectively function as part of the active boat monitoring system 110 of the watercraft.

As shown in FIG. 1A, each of the cameras 120, 130, 140, 150, 160, 170, 180 is linked to a computing device 220. Although the cameras 120, 130, 140, 150, 160, 170, 180 are shown physically linked to the computing device 220, in other embodiments the cameras 120, 130, 140, 150, 160, 170, 180 are wirelessly connected to the computing device 220 using, for example, WiFi® or Bluetooth®.

The computing device 220 includes at least a processor 230, a memory 240, a storage (not shown) and a display unit 250. The memory 240 contains at least an operating system 260, such as Linux®, OS X®, or Windows®, an image processing unit 270 (e.g., digital signal processor (DSP)) and an active watercraft monitoring process 300.

The active watercraft monitoring process 300 receives real time video feeds (e.g., digital images) from each of the cameras 120, 130, 140, 150, 160, 170, 180, stitches together the received real time video to produce a consolidated, uniform, simulated top view (i.e., aerial) view of the watercraft 100 and its surroundings that are displayed on the display unit 250. More particularly, a displayed image that a watercraft operator views includes a simulated graphical representation of their vessel in the middle of the surroundings captured by the video cameras, consolidated by the active watercraft monitoring process 300 and displayed by the active watercraft monitoring process 300. Unlike so called backup cameras that just display an actual image taken by a camera, the graphical representation of the present invention is not live but a synthesized simulated composite processed from the live video feeds. This graphical representation represents a simulated current view of the watercraft and its surroundings.

In embodiments, to enhance the active watercraft monitoring process 100, a navigation system that includes a global positioning system (GPS) and map data are linked to the active watercraft monitoring process 100 and processed in conjunction with the live video feeds.

While the active watercraft monitoring system is illustrated with seven cameras, the active watercraft monitoring system can be used with a watercraft that is equipped with any number of cameras placed in any number of positions around a watercraft.

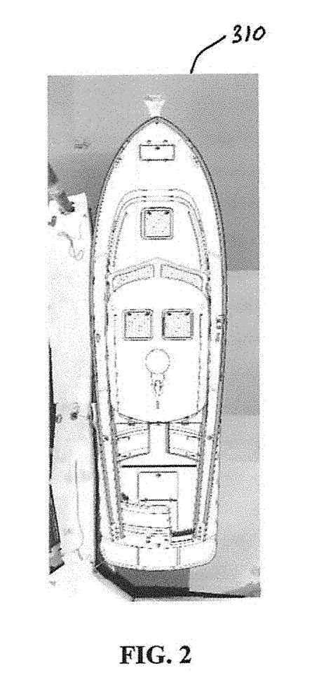

As shown in FIG. 2, an exemplary, consolidated, simulated, uniform, top view (i.e., aerial) 310 of the watercraft 100 and its surroundings that are displayed on the display unit is illustrated.

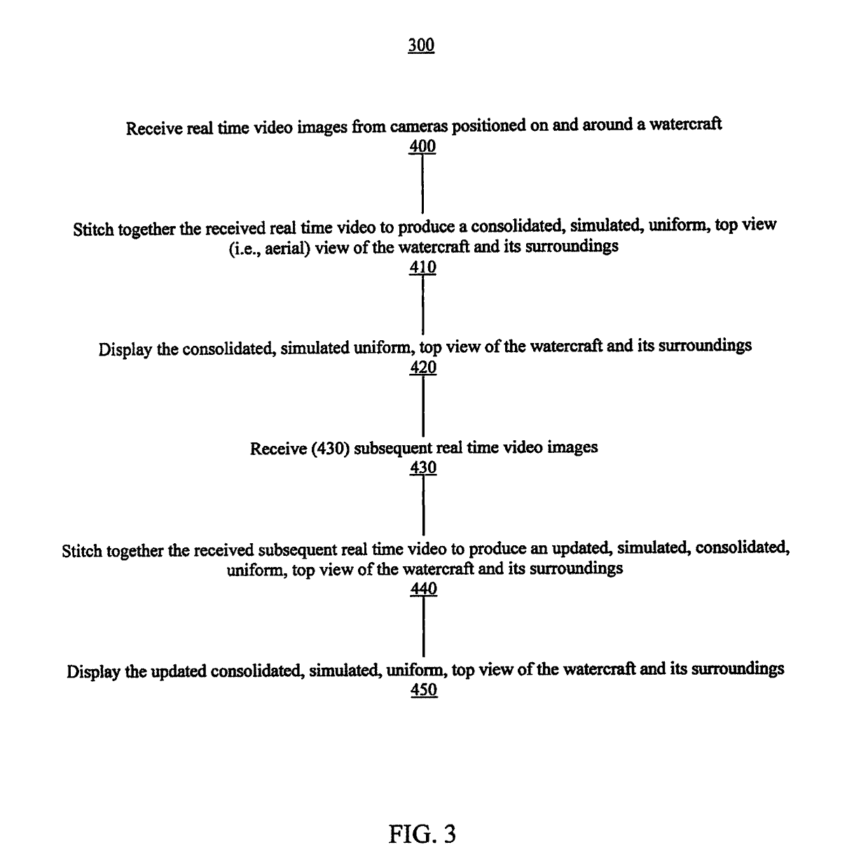

As shown in FIG. 3, the active watercraft monitoring process 300 includes receiving (400) real time video images from a number of cameras positioned on and around a watercraft.

Process 300 stitches together (410) the received real time video to produce a simulated, consolidated, uniform, top view (i.e., aerial) view of the watercraft and its surroundings. Stitching together (410) involves digital image processing. In one example, the digital image processing is accomplished using a digital signal processor (DSP).

Process 300 displays (420) the consolidated, simulated, uniform, top view (i.e., aerial) view of the watercraft and its surroundings.

Process 300 receives (430) subsequent real time video images.

Process 300 stitches together (440) the received subsequent real time video to produce an updated, simulated, consolidated, uniform, top view (i.e., aerial) view of the watercraft and its surroundings.

Process 300 displays (450) the updated consolidated, simulated, uniform, top view (i.e., aerial) view of the watercraft and its surroundings.

In alternate embodiments, the present invention is adapted to enable operators of other consumer, commercial or military vehicles to visualize the close proximity surroundings of their vehicles using multiple live video camera feeds. The live video feed is processed and then projected to a visible screen on the vehicle as a simulated image. The video stream generating the simulated image is live such that a distance of nearby obstacles can be accounted for visually when operating a vehicle in close proximity to the obstacles.

Various embodiments may be implemented using hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner or syntax, for instructing a computer to perform a certain function. The instructions may be implemented using any suitable high-level, low-level, object-oriented, visual, compiled and/or interpreted programming language.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A system comprising:
a plurality of cameras positioned on a watercraft to capture real time images of regions directly forward, rearward and laterally of the watercraft; and
an active watercraft monitoring process residing in a computing device positioned in the watercraft, the active watercraft monitoring process receiving real time video images from the plurality of cameras, processing the real time video images and generating a simulated image of the vessel in relationship to its surroundings in conjunction with the processed real time video images.

2. The system of claim 1 further comprising a display device, the display device displaying the simulated image of the watercraft in relationship to its surroundings.

3. The system of claim 1 wherein the plurality of cameras are physically linked to the computing device.

4. The system of claim 1 wherein the plurality of cameras are wirelessly linked to the computing device.

5. The system of claim 4 wherein the wireless link is wireless telecommunication equipment.

6. The system of claim 1 wherein the plurality of cameras comprise:
a forward port side camera; and
a forward starboard side camera.

7. The system of claim 6 wherein the plurality of cameras further comprise:
an amidships port side camera; and
an amidships starboard side camera.

8. The system of claim 7 wherein the plurality of cameras further comprise:
an astern port side camera; and
an astern starboard side camera.

9. The system of claim 8 wherein the plurality of cameras further comprise a stern camera.

10. A method comprising:
in a computing system comprising at least a processor, a memory and a display device, receiving real time video images from the plurality of cameras positioned on and about a vessel; and
generating a composite image from the received real time video images, the composite image comprising a simulated image of the vessel depicted in its surrounding environment.

11. The method of claim 10 further comprising displaying the component image on the display device.

12. The method of claim 10 wherein the plurality of cameras include one or more of a forward port side camera, a forward starboard side camera, an amidships port side camera, an amidships starboard side camera, an astern port side camera, an astern starboard side camera and a stern camera.

13. The method of claim 10 further comprising:
updating the composite image; and
displaying the updated composite image on the display device.

14. The method of claim 13 wherein updating the composite image comprises:
receiving subsequent real time video images from the plurality of cameras positioned on and about the vessel; and
generating the updated composite image from the received subsequent real time video images.

15. A non-transitory computer readable medium comprising instructions to be executed by a processor-based device, wherein the instructions, when executed by the processor-based device, perform operations, the operations comprising:
receiving real time video images from a plurality of cameras positioned on and about a vessel; and
generating a composite image from the received real time video images for display, the composite image comprising a simulated image of the vessel depicted in its surrounding environment.

16. The medium of claim 15 wherein the plurality of cameras include one or more of a forward port side camera, a forward starboard side camera, an amidships port side camera, an amidships starboard side camera, an astern port side camera, an astern starboard side camera and a stern camera.

17. The medium of claim 15 wherein the operations further comprise:
updating the composite image; and
displaying the updated composite image on the display device.

18. The medium of claim 17 wherein updating the composite image comprises:
receiving subsequent real time video images from the plurality of cameras positioned on and about the vessel; and
generating the updated composite image from the received subsequent real time video images.
